(19) United States
(12) Patent Application Publication
(10) Pub. No.: US 2014/0258577 A1
(43) Pub. Date: Sep. 11, 2014

(54) Wire Level Virtualization Over PCI-Express

(71) Applicant: FUTUREWEI TECHNOLOGIES, INC., Plano, TX (US)

(72) Inventors: Norbert Egi, Santa Clara, CA (US); Raju Joshi, Los Altos, CA (US); Guangyu Shi, Cupertino, CA (US)

(73) Assignee: FUTUREWEI TECHNOLOGIES, INC., Plano, TX (US)

(21) Appl. No.: 13/793,263

(22) Filed: Mar. 11, 2013

(51) Int. Cl. G06F 13/366

(52) U.S. Cl. CPC G06F 13/366
USPC 710/113

(57) ABSTRACT

A network element (NE) comprising a processor configured to receive a resource request via a Peripheral Component Interconnect (PCI) Express (PCI-e) network from a first device, wherein the first device is external to the NE, and query an access control list to determine whether the first device has permission to access a resource. The disclosure also includes an apparatus comprising a memory comprising instructions, and a processor configured to execute the instructions by allocating a resource of a shared device for use by an external device over a PCI-e network by updating a resource allocation table.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Data centers may comprise large clusters of servers. Data center servers may accept requests from users and respond to such requests. For example, servers may host data and transmit such data to a user upon request. A server may also be configured to host processes that perform various functionalities. As such, a user may transmit a request to a server to perform afunctionality, the server may perform the functionality by executing a process, and then the server may respond to the user with the results of the function. A server may comprise computing components, data storage components, communication components, and other components to process user requests and communicate with the user. Such components may be interconnected using various networking devices and techniques.

### SUMMARY

In one embodiment, the disclosure includes a network element (NE) comprising a processor configured to receive a resource request via a Peripheral Component Interconnect (PCI) Express (PCI-e) network from a first device, wherein the first device is external to the NE, and query an access control list to determine whether the first device has permission to access a resource.

In another embodiment, the disclosure includes an apparatus comprising a memory comprising instructions, and a processor configured to execute the instructions by allocating a resource of a shared device for use by an external device over a PCI-e network by updating a resource allocation table.

In another embodiment, the disclosure includes method comprising determining a first resource allocation for an external device by receiving data from a resource allocation table, and transmitting a first resource request to a first resource allocated to the external device, wherein the first resource request is transmitted to the first resource via a PCI-e network.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a server architecture employing a PCI-e interconnection.

FIG. 2 is a schematic diagram of another embodiment of a server architecture employing a PCI-e interconnection.

FIG. 3 is a schematic diagram of an embodiment of a shared device.

FIG. 4 is a signaling diagram of an embodiment of a method of dynamically allocating resources.

FIG. 5 is a schematic diagram of an embodiment of a NE.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In a server, processors and/or processor clusters may be interconnected with resources, such as process accelerators, memory storage devices, and input/output (I/O) devices by a PCI-e architecture and/or a related protocol(s) as set forth in PCI Special Interest Group (PCI-SIG) document PCI-e Base Specification Revision 3.0, which is hereby incorporated by reference. PCI-e may be employed to allow processors at the server level (e.g. within a single server) to share resources. With the increasing emphasis on cloud computing, there has been interest in expanding PCI-e to interconnect components at the rack level and/or data center level (e.g. interconnection between a plurality of servers and a shared blade server).

Disclosed herein is an architecture for sharing resource(s) between a plurality of servers over a PCI-e network without requiring Single-Root I/O Virtualization (SR-MV), Multi-Root I/O Virtualization (MR-MV), and/or other virtualization support. The architecture may comprise a plurality of computing nodes, a management entity, and one or more shared resources, which may be interconnected via the PCI-e network. Each server may comprise at least one processor. The shared device may comprise an access control list and/or a resource allocation table which may comprise permissions and resource allocation for each processor, respectively. The management entity may manage resource sharing by managing the access control list and/or the resource allocation table. As an example, the management entity may assign a unique bus identifier (BID) to each processor and associate permissions and/or resource allocation to the processor via the BID. The management entity may be positioned on the device comprising the shared resource or may be positioned in a separate component. Resources may be shared amongst processors and/or dynamically provisioned for exclusive use by a specific processor as needed. The servers and/or processors may be unaware of the sharing, which may promote security and isolation and may allow legacy devices to connect to the shared resources without attendant upgrades. The shared resources may comprise process accelerators such as application specific integrated circuits (ASICs), field programmable gate arrays (FPGA), graphics processing units (GPUs), digital signal processors (DSPs), etc., memory storage devices such as cache, long term storage, etc., and network communication devices such Ethernet controllers, transmitters, receivers, transceivers, etc.

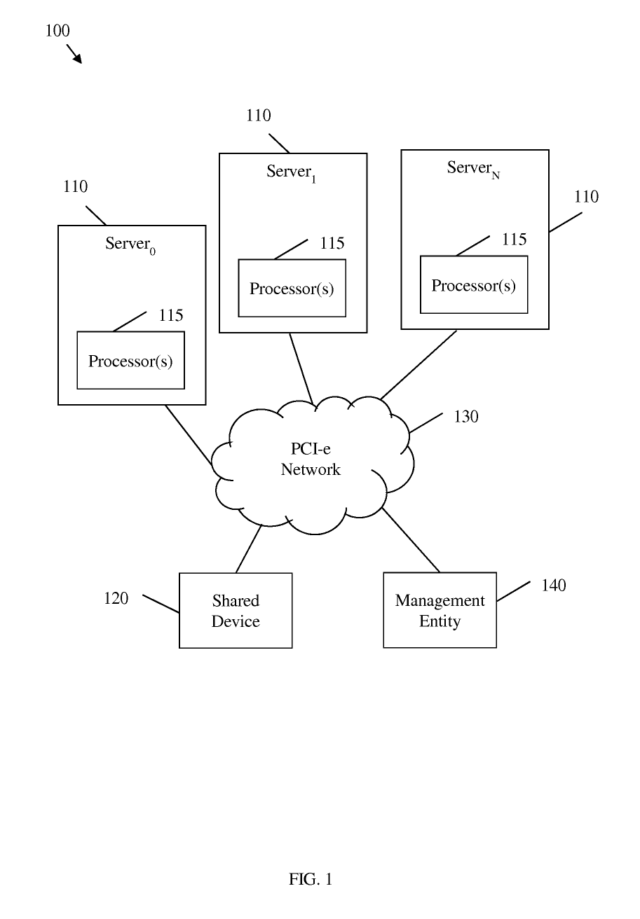

FIG. 1 is a schematic diagram of an embodiment of a PCI-e network architecture 100, which may be used to share resources between a plurality of servers 110 and related processors 115. Network 100 may comprise a plurality of servers 110, which may each comprise at least one processor 115 (e.g. a processor cluster). Servers 110 may be interconnected to a shared device 120 that comprises at least one resource. The resources of the shared device 120 may be allocated by a management entity. Access permissions for the servers 110 and processors 115 may also be managed by the management entity 140. The servers 110, shared device 120, and management entity 140 may be interconnected by a PCI-e network.

Servers 110 may be configured to host processes, data, and/or respond to user and/or administrator requests. Servers 110 may comprise processor(s) 115, which may execute commands to perform the functions which may be required of the server 110. Processors 115 may use multithreading and/or other technologies to process a plurality of requests substantially simultaneously. Processors 115 may comprise a single processor, a processor cluster, and/or groups of processor clusters. Processors 115 may receive input, process requests, and generate output. In order to perform functions, processors 115 may require access to resources which may transmit data to and from the processor (e.g. I/O), perform part of a process (e.g. process accelerators), and/or store data. Some resources may be located inside a server 110 and may be dedicated for the user of the processors 115 of that server 110. Other resources may be located in other components (e.g. shared device 120) and may be shared by a plurality of processors 115 in a plurality of servers 110.

Processors 115 may transmit resource requests to the shared device 120. The shared device may comprise a plurality of resources and may respond to such resource requests. For example, a shared device may comprise process accelerators such as application specific integrated circuits (ASICs), field programmable gate arrays (FPGA), graphics processing units (GPUs), digital signal processors (DSPs), etc. Process accelerators may be optimized for a specific task and may perform such specific tasks more quickly and/or efficiently than a general processing unit (e.g. processors 115). A processor 115 wishing to offload all or part of a particular process may transmit a resource request to shared device 120, and shared device 120 may employ process accelerators to complete the process and transmit resulting data back to the requesting processor 115. As another example, shared device 120 may comprise memory storage devices such as cache (e.g. temporary storage) and long term storage (e.g. disk drives, solid state drives, redundant array of independent disks (RAID), etc.) A shared device 120 comprising a memory storage device may store data from a processor 115 and return such data to the processor 115 on request. As another example, shared device 120 may comprise network communication devices such as an Ethernet card, an optical interconnect, an Open Systems Interconnection (OSI) model layer 1 communications device, and/or any other transmitter, receiver, and/or transceiver. A shared device 120 comprising a network communication device may communicate with other components across a transport network and communicate such data to/from the associated processor 115 across the PCI-e network 130. It should be noted that shared device 120 may be dedicated to a single resource, a single type of resource, or may comprise a plurality of unrelated resources. It should also be noted that while only one shared device 120 is shown for reasons of clarity, a plurality of shared devices 120 may be easily employed in network 100.

The management entity 140 may manage permissions and/or resource allocations for one or more shared devices 120. The management entity 140 may assign a BID to each server 110, each processor 115, each shared device 120, and/or combinations thereof. The management entity 140 may also dynamically assign permissions and/or allocate resources to servers 110 and/or processors 115 by indicating changes to permissions of a BID and/or indicating which resources are allocated to a BID, respectively, at a specified time. The management entity 140 may communicate with processors 115 and/or servers 110 and may maintain an awareness resource needs of network 100, a subportion of network 100, a particular server 110, and/or particular processors 115 so that resource allocations may be changed as the needs of the network 100 and associated components change.

Servers 110, shared device 120, and/or management entity 140 may each be positioned on a separate NE (e.g. network node) and be interconnected via PCI-e network 130. PCI-e network 130 may comprise a switched fabric of parallel and/or serial buses, which may interconnect the components of network 100. For example, PCI-e network 130 may connect to servers 110 and/or connect directly to processors 115 and interconnect the servers 110/processors 115 with shared devices 120 and/or management entity 140. PCI-e network 130 may transport communications between the network 100 components using switching mechanisms and associated data communication protocols.

Network 100 may be implemented such that servers 110 and/or processors 115 may request resources of shared device 120 without knowledge of the associated resource allocation. As such, sharing may be extended to legacy servers 110 and/or processors 115 without attendant upgrades (e.g. Virtualization Technology for directed I/O (VT-d), etc.) The management entity 140 may maintain awareness of the resource needs of the network 100, assign a BID to each processor 115 and manage the resource allocations and permissions of the shared device 120. When a shared device 120 receives a resource request from a server 110/processor 115, the shared device may provide access to appropriate resources based on the allocations and permissions set by the management entity. The resource sharing of network 100 may implemented in a simple manner in comparison to more complex resource sharing implementations such as SR-IOV and/or MR-IOV. Unlike SR-IOV and/or MR-IOV, which may require standardization to allow servers 110 and/or processors 115 to be aware of the resources of the shared device 120, the resource sharing of network 100 may not require any modification of software operating on the servers 110 and/or processors 115. As such, servers 110 and/or processors 115 may not be required to specify the resources to be allocated as part of a resource request.

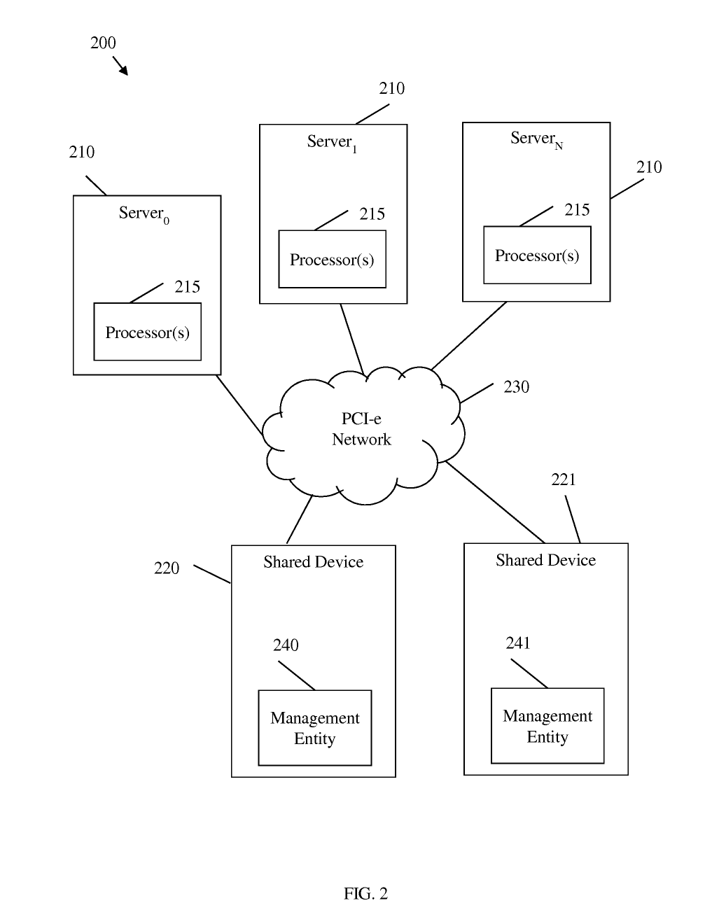

FIG. 2 is a schematic diagram of another embodiment of a PCI-e network architecture 200. Network 200 comprises a plurality of servers 210 each comprising processor(s) 215, shared devices 220-221 and PCI-e network 230, which may be substantially similar to servers 110, processors 115, shared device 120, and PCI-e network 130, respectively. Network 200 may further comprise management entities 240-241 which may be similar to management entity 140, but may be positioned in shared devices 220-221, respectively, instead of in a separate NE. Management entity 240 may manage resource allocations and permissions for resources of shared device 220 and management entity 241 may manage resource allocations and permissions for resources of shared device 221, respectively. Management entities 240-241 may be restricted to managing resources/permissions for the device in which they are positioned or may also manage the resources/permissions of other connected shared devices (e.g. shared devices without an onboard management entity).

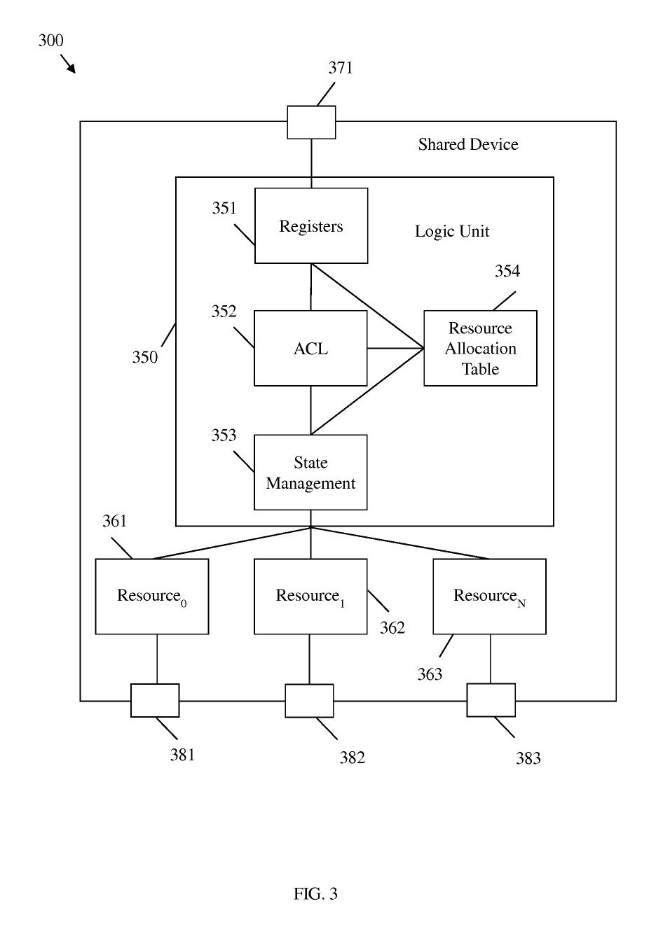

FIG. 3 is a schematic diagram of an embodiment of a shared device 300, which may be substantially similar to shared devices 120, 220, and/or 221. Shared device 300 may comprise a logic unit 350, which may comprise registers 351 (e.g. base address registers (BARs)), an access control list (ACL) 352, a resource allocation table 354, and a state management device 353. The logic unit 350 may communicate data across a PCI-e network (e.g. PCI-e network 130 and/or 230) via PCI port 371 and access resources 361-363. Resources 361-363 may communicate with other components via I/O ports 381-383 depending on the nature of resources 361-363.

Logic unit 350 may be a general processing unit, an ASIC, or other device configured to process requests. Logic unit 350 may receive a resource request via the PCI port 371 from a processor such as processor 115. The resource request may be received at the registers 351. The request may comprise a BID associated with the processor. The logic unit 350 may query the ACL 352 to determine what permissions (e.g. read, write, execute, etc.) are associated with the BID. If the BID does not have permission to perform an action associated with the resource request, the logic unit 350 may drop the request and/or transmit an error to the processor. Otherwise, the logic unit 350 may query the resource allocation table 354 to determine the resource allocation associated with the BID. Once the logic unit 350 determines the resource allocation for the processor, the logic unit 350 may transmit the request to the state management device 353. The state management device 353 may maintain the state of the PCI-e connections and interpret the resource request in light of the resource allocation. The state management device 353 may generate a packet to the resource(s) allocated to the processor (e.g. resource 381, 382, and/or 383) in a format that may be understood by the allocated resource. The state management device 353 may also maintain a queue and transmit the packets to the resources 381-383 based on the availability of a specified resource 381-383.

Resources 381-383 may be process accelerators, data storage devices, network communication devices, or combinations thereof. Resources 381-383 may receive the requests from the state management device 353, interpret the requests, and respond based on the request and the nature of the resource 381-383. For example, a process accelerator may perform the requested process and transmit the results back to the requesting processor via logic unit 350 and via PCI port 371, through I/O ports 381-383, or combinations thereof. As another example, a data storage device may store and/or retrieve data to/from storage positioned inside the shared device 300 or connected to the shared device 300 via I/O ports 381-383, e.g. via a serial advanced technology attachment (SATA) connection. As another example, a network communication device may receive a packet for transmission from the state management device 353 and transmit the packet via I/O ports 381-383, for example using an Ethernet connection and via a Serial Gigabit Media Independent Interface (SGMII) interface. As another example, a network communication device may receive a packet from I/O ports 381-383 and forward the packet to the logic unit 350 for transmission to the appropriate processor via PCI-e port 371.

Resources 381-383 may be dedicated to a particular processor at a specified time or may be shared (e.g. based on the queue at the state management device 353) based on the resource allocation in the resource allocation table 354. Resources may therefore be reallocated dynamically by updating the resource allocation table 354 and/or the permissions at the access control list 352. As discussed above, the resource allocation table 354 and/or the access control list 352 may be managed by a management entity such as management entity 140, 240, and/or 241. In the case of management entity 240 and/or 241, the management entity may be implemented on logic unit 350. In the case of management entity 140, the management entity may update the resource allocation table 354 and/or the access control list 352 by a communication with logic unit 350 via PCI-e port 371, I/O ports 381, 382, and/or 383, and/or by some other connection.

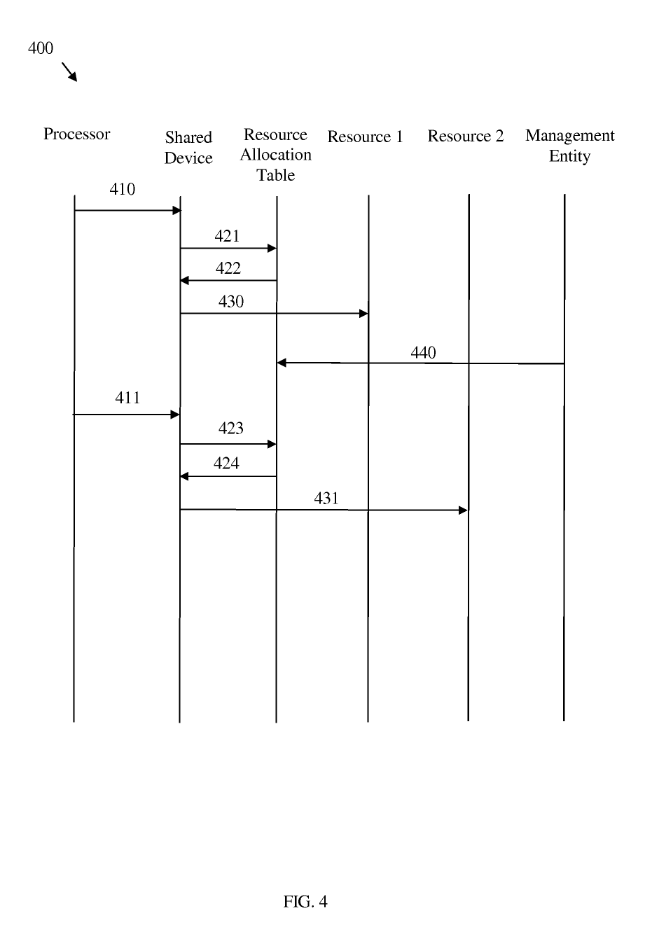

FIG. 4 is a signaling diagram of an embodiment of a method 400 of dynamically allocating resources. Method 400 may be implemented on a processor, a shared device, a resource allocation table, a resource 1, a resource 2, and a management entity, which may be substantially similar to processors 115 and/or 215, shared device 120, 220, and/or 300, resource allocation table 354, resources 361, 362, and/or 363, and management entity 140, 240, and/or 241, respectively. The processor may send a resource request 410 to the shared device over the PCI-e network. The shared device may determine a resource allocation for the processor by sending a query 421 to the resource allocation table. The query 421 may comprise a BID for the processor. The resource allocation table may reply 422 with a resource allocation for the BID, which may indicate resource 1 is allocated to the processor. Based on the resource allocation received in the reply 422, the shared device may covert the resource request into a packet 430 that can be received by resource 1 and may transmit the packet 430 to resource 1.

At a later time, the management entity may determine to update the resource allocation for the processor. The management entity may send an update message 440 to the resource allocation table. The update message 440 may comprise data indicating the BID of the processor and that resource 2 is allocated to the BID. The processor may send a resource request 411 to the shared device, in a substantially similar manner to resource request 410. The shared device may send a query 423 to the resource allocation table and receive a reply 424 indicating that resource 2 is allocated to the BID associated with the processor. Based on the updated resource allocation received in reply 424, the shared device may covert the resource request into a packet 431 that can be received by resource 2 and may transmit the packet 431 to resource 2. By implementing method 400, a management entity may dynamically change a resource allocation for a particular processor without the processor being aware of the allocation. Method 400 may allow resource 1 and/or resource 2 to be shared between multiple processors without requiring the processors manage or even be aware of such sharing.

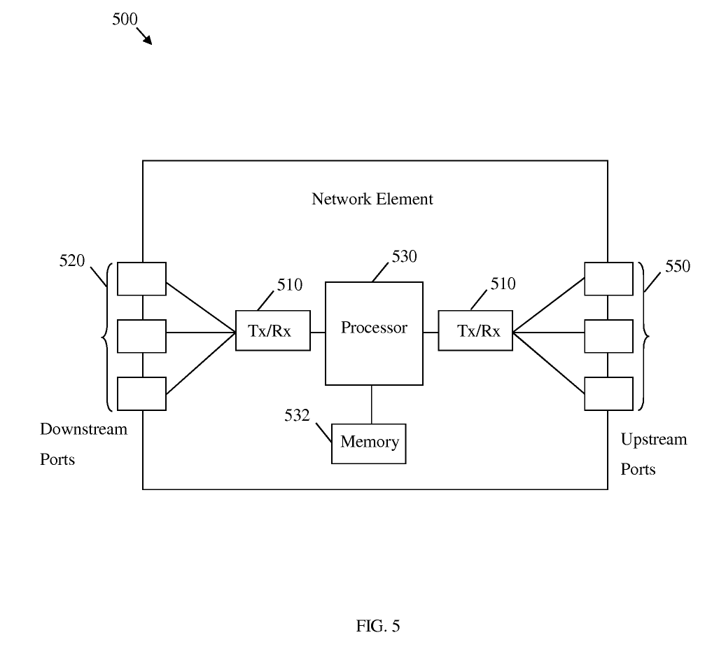

FIG. 5 is a schematic diagram of an embodiment of a network element (NE) 500, which may comprise a server 110 and/or 210, a shared device 120, 220, 221, and/or 300, and/or a management entity 140, 240, and/or 241. One skilled in the art will recognize that the term NE encompasses a broad range of devices of which NE 500 is merely an example. NE 500 is included for purposes of clarity of discussion, but is in no way meant to limit the application of the present disclosure to a particular NE embodiment or class of NE embodiments. At least some of the features/methods described in the disclosure, for example method 400 of dynamically allocating resources, may be implemented in whole or in part in a network apparatus or component such as an NE 500. For instance, the features/methods in the disclosure may be implemented using hardware, firmware, and/or software installed to run on hardware. The NE 500 may be any device that transports frames through a network, e.g., a switch, router, bridge, server, a client, etc. As shown in FIG. 5, the NE 500 may comprise transceivers (Tx/Rx) 510, which may be transmitters, receivers, or combinations thereof. A Tx/Rx 510 may be coupled to plurality of downstream ports 520 for transmitting and/or receiving frames from other nodes, a Tx/Rx 510 coupled to plurality of upstream ports 550 for transmitting and/or receiving frames from other nodes. For example, Tx/Rx 510 and downstream ports 550 may comprise resources 361-363 and/or I/O ports 381-383, while upstream ports 420 may comprise PCI-e port 371. A processor 530 may be coupled to the Tx/Rxs 510 to process the frames and/or determine which nodes to send frames to. The processor 530 may comprise one or more multi-core processors and/or memory devices 532, which may function as data stores, buffers, etc. Processor 530 may be implemented as a general processor or may be part of one or more application specific integrated circuits (ASICs) and/or digital signal processors (DSPs). As an example, processor 530 and/or memory devices 532 may comprise processors 115, processors 215, logic unit 350, management entity 140, management entity 240, and/or management entity 241. The downstream ports 520 and/or upstream ports 550 may contain electrical and/or optical transmitting and/or receiving components. NE 500 may or may not be a routing component that makes routing decisions. It should be noted that not all network elements may comprise all of the components discussed herein. For example, some shared devices (e.g. shared devices 120, 220, 221, and/or 300) may comprise upstream ports 550 and may not comprise downstream ports 520, etc.

It is understood that by programming and/or loading executable instructions onto the NE 500, at least one of the processor 530, downstream ports 520, Tx/Rxs 510, memory 532, and/or upstream ports 550 are changed, transforming the NE 500 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Ru, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. The use of the term “about” means+10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A network element (NE) comprising:
a processor configured to:
receive a resource request via a Peripheral Component Interconnect (PCI) Express (PCI-e) network from a first device, wherein the first device is external to the NE; and
query an access control list to determine whether the first device has permission to access a resource.

2. The NE of claim 1, wherein the processor is further configured to query a resource allocation table to determine if a resource is allocated to the first device.

3. The NE of claim 2, wherein the processor is further configured to:
send the resource request to a queue associated with the resource when the first device has permission to access the resource and when the resource is allocated to the first device.

4. The NE of claim 2, wherein the resource is allocated only to the first device.

5. The NE of claim 2, wherein the processor is further configured to receive a resource request via the PCI-e network from a second device, wherein the second device is external to the NE, and wherein the resource is allocated to be shared between the first device and the second device.

6. The NE of claim 2, wherein a bus identifier (BID) is assigned to the first device, and wherein the BID associates the first device to the resource in the resource allocation table.

7. The NE of claim 2 further comprising a management entity, wherein the management entity is configured to update the resource allocation table, the access control list, or combinations thereof.

8. The NE of claim 7, wherein the processor is further configured to implement the management entity.

9. The NE of claim 2, wherein the resource comprises at least one of a hardware accelerator, a network communication device, or a memory storage device.

10. The NE of claim 2, wherein functions of the processor are implemented in hardware and wherein the functions of the processor are not implemented in software or software on hardware.

11. An apparatus comprising:
a memory comprising instructions; and
a processor configured to execute the instructions by:
allocating a resource of a shared device for use by an external device over a Peripheral Component Interconnect (PCI) Express (PCI-e) network by updating a resource allocation table.

12. The apparatus of claim 11, wherein the processor is further configured to assign a bus identifier (BID) to the external device.

13. The apparatus of claim 12, wherein allocating the resource comprising associating the resource with the BID of the external device.

14. The apparatus of claim 11, wherein the processor is further configured to update an access control list by associating permissions of the resource with the external device.

15. The apparatus of claim 11, wherein the resource is allocated to the external device without receiving a request from the external device that specifies the resource to be allocated.

16. A method comprising:
determining a first resource allocation for an external device by receiving data from a resource allocation table; and
transmitting a first resource request to a first resource allocated to the external device,
wherein the first resource request is transmitted to the first resource via a Peripheral Component Interconnect (PCI) Express (PCI-e) network.

17. The method of claim 16, wherein the resource allocation table is updated by a management entity subsequent to transmitting the first resource request, and wherein the updated resource allocation table comprises a second resource allocation for the external device that is different from the first resource allocation.

18. The method of claim 16 further comprising:
receiving a second resource request from the external device after the resource allocation table is updated;
determining the second resource allocation for the external device by receiving data from the resource allocation table after the resource allocation table is updated; and
transmitting the second resource request to a second resource allocated to the external device.

19. The method of claim 18, wherein the external device is a legacy device that is not configured to share resources and wherein the external device is unaware of the first resource allocation and the second resource allocation.

20. The method of claim 18, wherein the resource allocation table comprises a bus identifier (BID) assigned to the external device, wherein first resource allocation is determined by determining that the first resource is associated with the BID before the resource allocation table is updated, and wherein second resource allocation is determined by determining that the second resource is associated with the BID after the resource allocation table is updated.
